(19) United States
(12) Patent Application Publication
(10) Pub. No.: US 2013/0265344 A1
(43) Pub. Date: Oct. 10, 2013

(54) DRIVING DEVICE, DRIVING METHOD, AND SYSTEM FOR DISPLAY DEVICE

(71) Applicant: Naoya Taniguchi, Osaka-shi (JP)

(72) Inventor: Naoya Taniguchi, Osaka-shi (JP)

(73) Assignee: Sharp Kabushiki Kaisha, Osaka-shi, Osaka (JP)

(21) Appl. No.: 13/994,528

(22) PCT Filed: Dec. 9, 2011
(86) PCT No.: PCT/JP2011/006899

§ 371 Date: Jun. 14, 2013

(30) Foreign Application Priority Data
Dec. 17, 2010 (JP) 2010-281259

(51) Int. Cl. G09G 3/36

(52) U.S. Cl. CPC G09G 3/3607
USPC 345/690

(57) ABSTRACT

A smoothing circuit is configured such that: a voltage between two voltages having been divided by voltage dividing resistors near a node to which an intermediate reference voltage is applied is further divided by buffers and voltage dividing resistors into intermediate voltages which are output as grayscale voltages, respectively. Also, a voltage between the voltage having been divided by the voltage dividing resistors and a voltage having been divided by the voltage dividing resistors, and a voltage between the voltage having been divided by the voltage dividing resistors and a voltage having been divided by the voltage dividing resistors are further divided, thereby generating intermediate voltages which are output as grayscale voltages and, respectively.

### TECHNICAL FIELD

The present disclosure relates to driving devices, driving methods and systems for display devices which carry out grayscale display.

### BACKGROUND ART

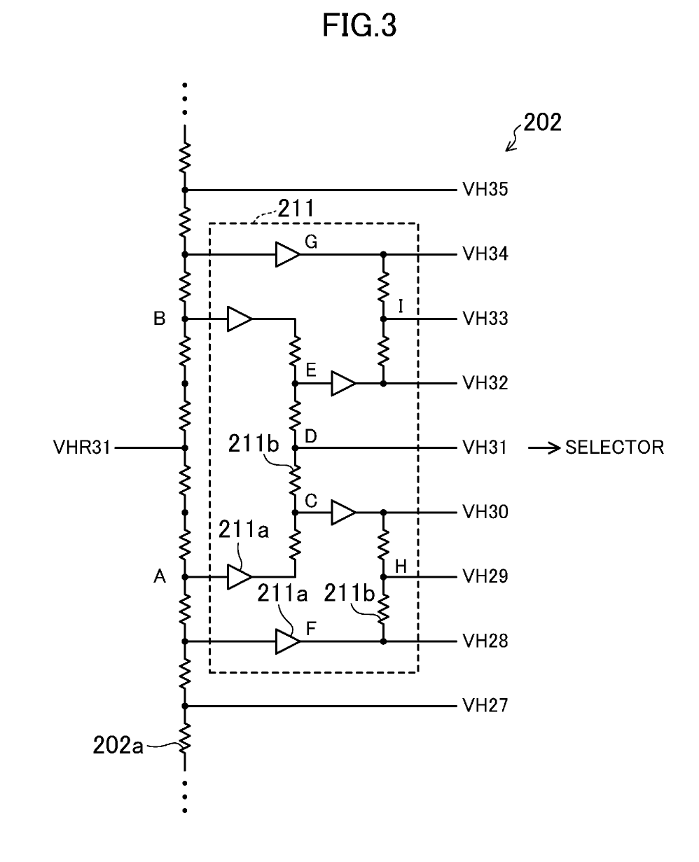

Driving devices for display devices such as liquid crystal display devices each include a grayscale voltage generating circuit which generates a plurality of grayscale voltages and a selector which selects, in accordance with a grayscale data signal, one from the generated grayscale voltages, and thereby outputs a voltage corresponding to a grayscale to be displayed. The grayscale voltage generating circuit is configured to generate the plurality of grayscale voltages by dividing a voltage between two reference voltages by means of a plurality of resistors connected in series. It is a known technique to apply intermediate reference voltages to, e.g., five nodes selected from the nodes through which the plurality of resistors connected to one another in series such that the grayscale voltages generated by the grayscale voltage generating circuit can be adjusted to desired voltage values (see, e.g., Patent Document 1 (FIG. 3)). The above configuration, in which the grayscale voltages generated by the grayscale voltage generating circuit are adjusted by setting the intermediate reference voltages, makes it relatively easy to obtain a desired grayscale display characteristic.

### CITATION LIST

### Patent Document

PATENT DOCUMENT 1: Japanese Patent Publication No. 2001-100711

### SUMMARY OF THE INVENTION

### Technical Problem

The above configuration in which the intermediate reference voltages are applied, however, has a disadvantage as follows: Although it is possible to set, as desired, the voltages themselves at the nodes through which the resistors are connected to one another and to which the intermediate reference voltages are applied, variation rates of voltages, i.e., grayscale-by-grayscale variations in voltage at the nodes sandwiching each of the nodes to which the intermediate reference voltages are applied are different from one another in a discontinuous manner. Therefore, when displayed grayscales change temporally or spatially relative to respective grayscales corresponding to the nodes, unnatural changes in brightness and decrease in image quality adversely tend to occur.

It is therefore an object of the present disclosure to provide a driving device, a driving method, and a system for a display device which have an advantage that, when two reference voltages are applied to both ends of a sequence of resistors which are connected to one another in series through nodes and an intermediate reference voltage is applied to at least one of the nodes, grayscale-by-grayscale variations in voltage near the at least one node to which the intermediate reference voltage is applied can be reduced and image quality can be easily improved.

### Solution to the Problem

To achieve the object, a first aspect of aspect of the present disclosure relates to a driving device configured to drive a display device by outputting a grayscale voltage in accordance with a grayscale data signal, including: a sequence of resistors connected to one another in series through nodes in such a manner that a highest reference voltage is applied to one end of the sequence of resistors, a lowest reference voltage is applied to the other end of the sequence of resistors, and at least one intermediate reference voltage is applied to at least one of the nodes; and at least one smoothing circuit provided across ones of the nodes sandwiching the at least one node to which the intermediate reference voltage is applied and configured to smooth a voltage between the ones of the nodes sandwiching the at least one node to which the intermediate reference voltage is applied.

The configuration according to the first aspect can reduce grayscale-by-grayscale variations in voltage near the node to which the intermediate reference voltage is applied and thereby can easily improve image quality.

A second aspect of the present disclosure is the driving device according to the first aspect, wherein the smoothing circuit includes two buffers configured to buffer voltages at two of the nodes sandwiching the at least one node to which the intermediate reference voltage is applied, and a plurality of resistors configured to generate an intermediate voltage by dividing a voltage between voltages output by the two buffers.

The configuration according to the second aspect prevents the voltages at the nodes located near the node to which the intermediate voltage is applied from varying due to influence of current passing through the resistors generating the intermediate voltage, resulting in that an accurate ratio of voltage division can be relatively easily set.

A third aspect of the present disclosure is the driving device according to the first or second aspect, wherein the smoothing circuit includes voltage dividing circuits which are each configured to generate an intermediate voltage by dividing a voltage between two voltages, and are provided in multiple stages.

The configuration according to the third aspect can further reduce the grayscale-by-grayscale variations in voltage.

A fourth aspect of the present disclosure is the driving device according to any one of the first to three aspects, wherein the at least one intermediate reference voltage comprises a plurality of intermediate reference voltages, the plurality of intermediate reference voltages are applied to ones of the nodes through which the resistors are connected to one another, and the smoothing circuit is provided in relation to each of the nodes to which the intermediate reference voltages are applied.

With the configuration according to the fourth aspect, smoothing effects are obtained in a wide range of grayscales.

A fifth aspect of the present disclosure is the driving device according to any one of the first to fourth aspects and further including a selector configured to select, according to the grayscale data signal, one voltage from the voltages at the nodes through which the resistors are connected to one another and the voltage output by the smoothing circuit.

With the configuration according to the fifth aspect, suitable grayscale voltages are output in accordance with the grayscale data signals, and therefore, a grayscale characteristic can be easily improved.

A sixth aspect of the present disclosure is the driving device according to any one of the first to fifth aspects and further including a grayscale compensator configured to output, based on successive data on grayscales, the grayscale data signal which is compensated such that grayscale transition is enhanced.

A seventh aspect of the present disclosure is the driving device according to the sixth aspect, wherein the grayscale compensator includes a lookup table for determining compensated data on grayscales with respect to representative grayscales of the successive data on grayscales, and is configured to obtain, with respect to data on grayscales other than the representative grayscales, compensated data on grayscales by interpolation.

According to the sixth and seventh aspects, it is easy to set the voltages in particularly flexible manner and to achieve rapid response and high image quality.

An eighth aspect of the present disclosure is a method for driving a display device by outputting a grayscale voltage in accordance with a grayscale data signal, including: applying a highest reference voltage to one end of a sequence of resistors connected to one another in series through nodes, a lowest reference voltage to the other end the sequence of resistors, and an intermediate reference voltage to at least one of the nodes; and generating a voltage for driving the display device based on a voltage obtained by smoothing a voltage between ones of the nodes sandwiching the at least one node to which the intermediate reference voltage is applied

As described above, the configuration according to the eighth aspect can reduce the grayscale-by-grayscale variations in voltage near the node to which the intermediate reference voltage is applied, and can generate a driving voltage which improves image quality.

A ninth aspect of the present disclosure is a system including the driving device according to the first aspect and a display device driven by the driving device according to the first aspect.

A tenth aspect of the present disclosure is the system according to the ninth aspect, wherein the display device is a liquid crystal display device.

With ninth and tenth aspects, a system for a display device with high image quality, as described above, can be easily obtained.

### ADVANTAGES OF THE INVENTION

According to the present disclosure, display image quality can be easily improved by reducing grayscale-by-grayscale variations in voltage near a node to which an intermediate reference voltage is applied.

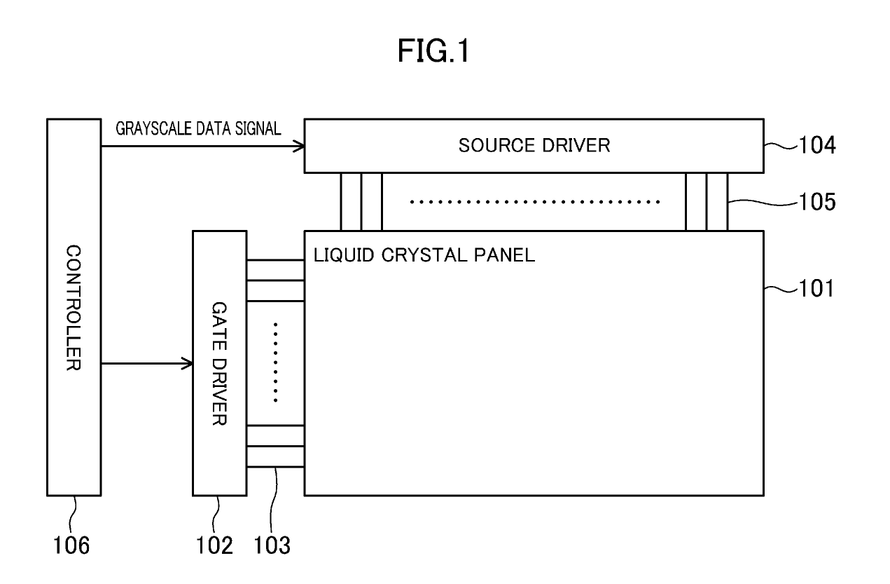

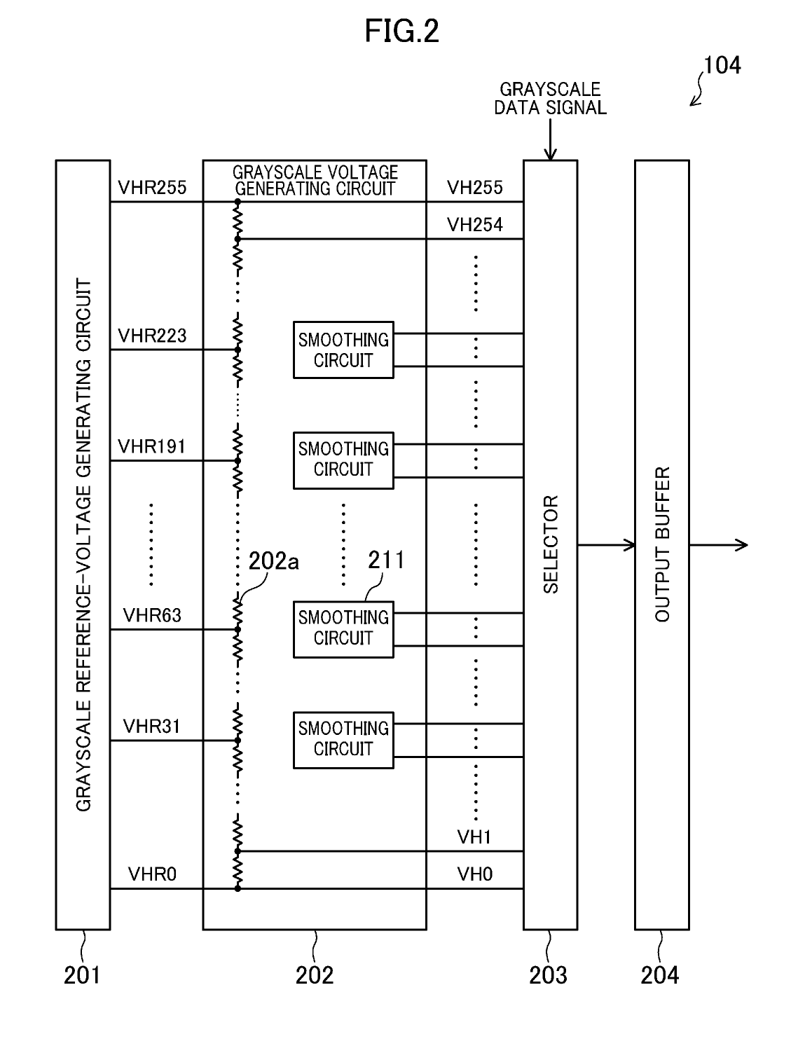

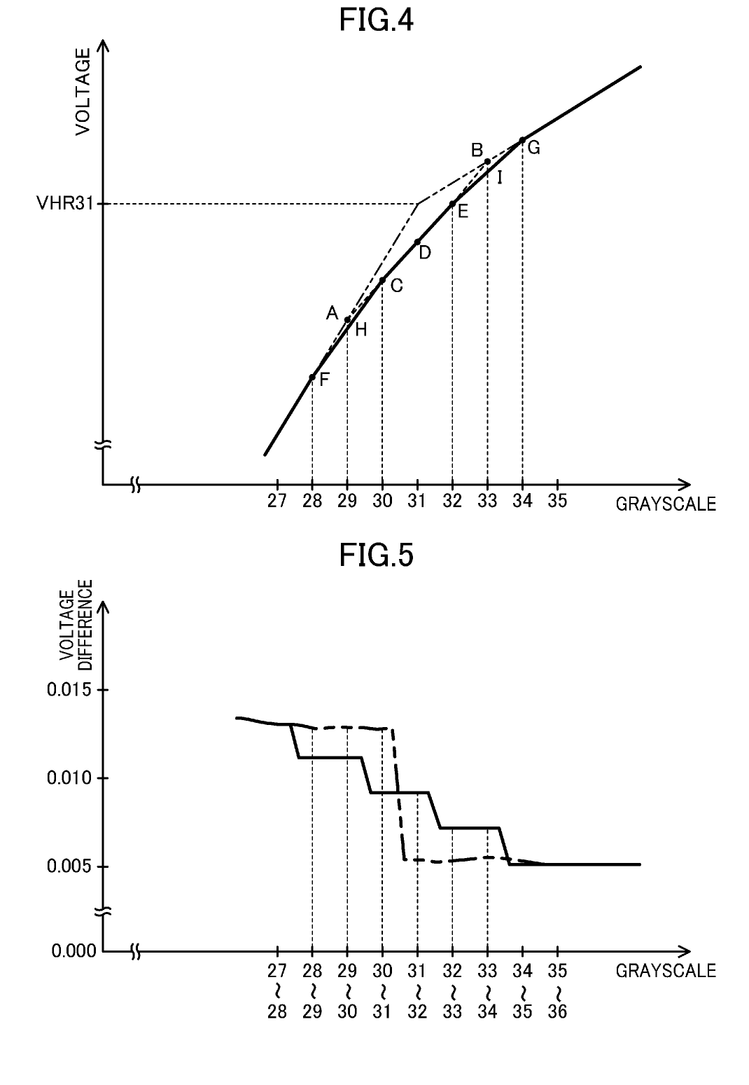

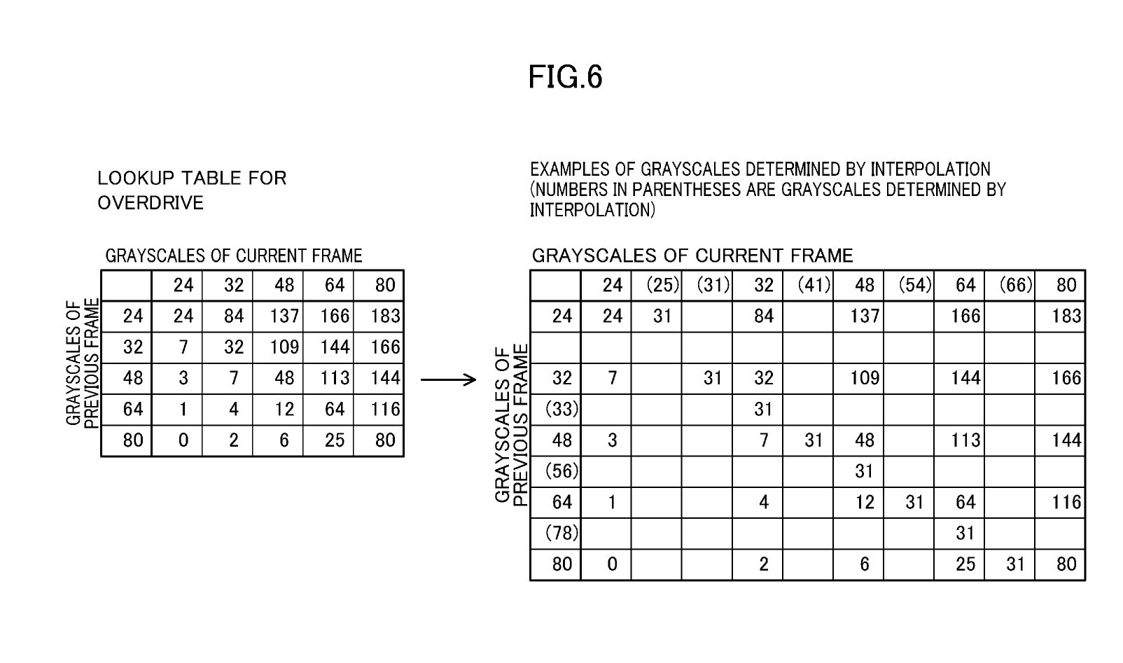

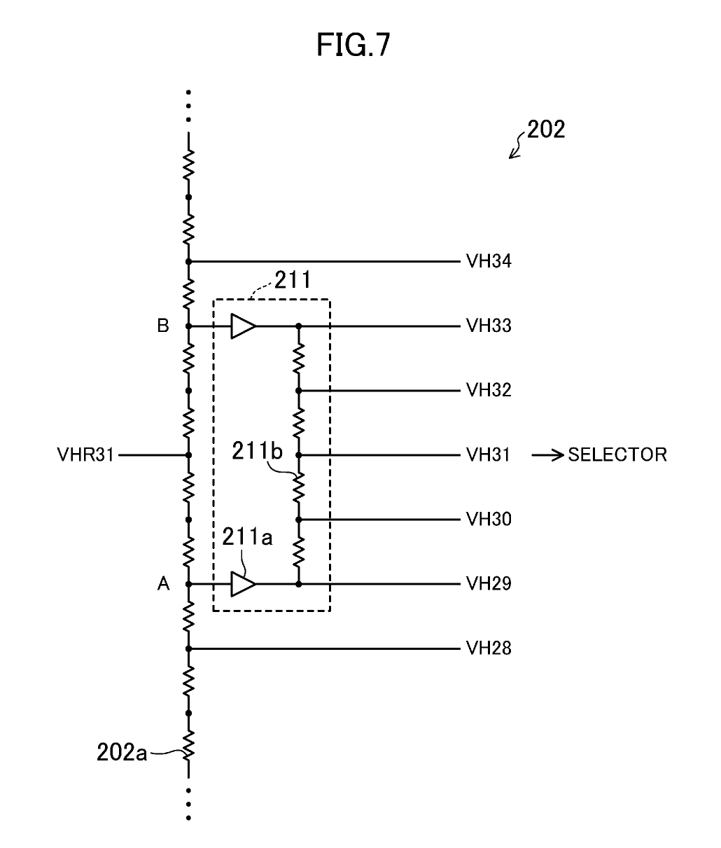

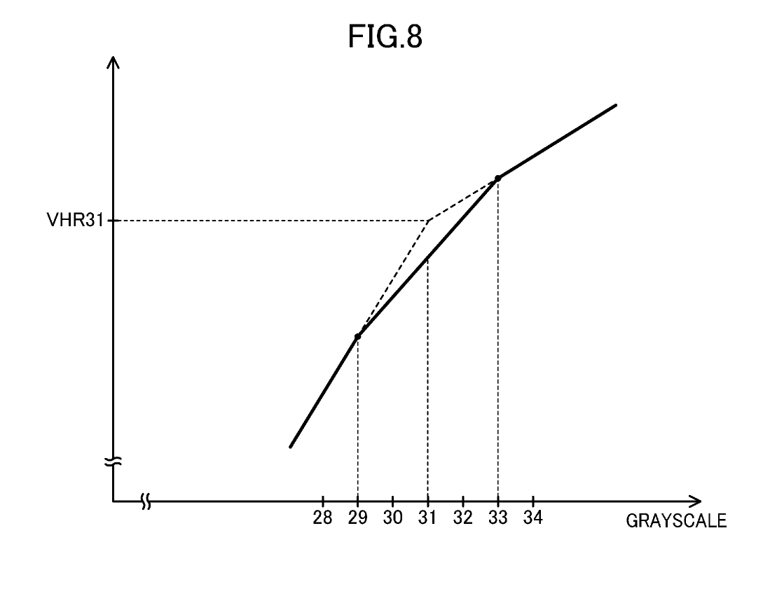

### BRIEF DESCRIPTION OF THE DRAWINGS

[FIG. 1] FIG. 1 is a block diagram schematically illustrating a liquid crystal display device according to an embodiment of the present disclosure.

[FIG. 2] FIG. 2 is a block diagram illustrating in detail a configuration of a source driver 104.

[FIG. 3] FIG. 3 is a circuit diagram illustrating in detail a configuration of a grayscale voltage generating circuit 202.

[FIG. 4] FIG. 4 is a graph showing a grayscale-voltage characteristic.

[FIG. 5] FIG. 5 is a graph showing a grayscale-voltage difference characteristic.

[FIG. 6] FIG. 6 shows examples of a lookup table for overdrive and interpolation.

[FIG. 7] FIG. 7 is a circuit diagram illustrating a variation of the grayscale voltage generating circuit 202.

[FIG. 8] FIG. 8 is a graph showing a grayscale-voltage characteristic of the grayscale voltage generating circuit 202 illustrated in FIG. 7.

### DESCRIPTION OF EMBODIMENTS

An embodiment of the present disclosure will be described below in detail with reference to the drawings. In the embodiment and variations described below, components having a similar function are denoted by the same reference character in the drawings, and detailed descriptions of such components are not repeated.

A source driver for use in an active matrix type liquid crystal display device is now described as an exemplary driving device for a display device according to the present disclosure. As shown in FIG. 1, the liquid crystal display device includes a liquid crystal panel 101, a gate driver 102, the source driver 104 that is the driving device of the present disclosure, and a controller 106. The gate driver 102 is configured to select display lines by selectively activating gate lines 103. As will be detailed later, the source driver 104 is configured to output voltages in accordance with grayscale data signals, and to apply the voltages, through source lines 105, to pixels of the display lines selected by the gate driver 102. The controller 106 is configured to output, e.g., the grayscale data signals to be provided to the source driver 104 and timing signals to be provided to the gate driver 102.

As shown in FIG. 2, the source driver 104 includes a grayscale reference-voltage generating circuit 201 which is configured to generate, e.g., reference voltages VHR0-VHR255 at intervals of 32 grayscales, a grayscale voltage generating circuit 202 which is configured to generate, e.g., grayscale voltages VH0-VH255 covering 256 grayscales, a selector 203 which is configured to select one grayscale voltage in accordance with the grayscale data signal, and an output buffer 204 which is configured to output the selected grayscale voltage at low impedance to the source lines 105.

The grayscale voltage generating circuit 202 includes voltage dividing resistors 202a which are connected in series and configured to divide voltages between the reference voltages, and smoothing circuits 211. Specifically, for example, 255 voltage dividing resistors 202a are connected in series through nodes between the lowest reference voltage VHR0 and the highest reference voltage VHR255. Among the nodes through which the voltage dividing resistors 202a are connected to one another, seven nodes are subjected to application of intermediate reference voltages VHR31, VHR63, . . . The lowest reference voltage VHR0, the highest reference voltage VHR255, and some of the divided voltages of the nodes are directly output as grayscale voltages VH0, VH1, . . . , VH254 and VH255, to the selector 203. On the other hand, the voltages divided near the nodes to which the intermediate reference voltages VHR31, VHR63, . . . are applied are input to the smoothing circuits 211.

As illustrated in FIG. 3, the smoothing circuits 211 are each configured as follows, for example. A voltage between two voltages (A, B) having been divided by the voltage dividing resistors 202a near the node to which the intermediate reference voltage is applied is further divided by buffers 211a and voltage dividing resistors 211b into intermediate voltages (C, D, E). The intermediate voltages (C, D, E) are then output as the grayscale voltages VH30, VH31, and VH32, respectively. In the embodiment illustrated in FIG. 3, a voltage between the voltage (C) which has been divided by the voltage dividing resistors 211b and a voltage (F) which has been divided by the voltage dividing resistors 202a is further divided, thereby generating an intermediate voltage (H) which is output as the grayscale voltage VH29. In a similar manner, a voltage between the voltage (E) which has been divided by the voltage dividing resistors 211b and a voltage (G) which has been divided by the voltage dividing resistors 202a is further divided, thereby generating an intermediate voltage (I) which is output as the grayscale voltage VH33.

Thus, in this embodiment, the intermediate reference voltages are set in the following manner: The intermediate reference voltages such as VHR31 are not directly output as, e.g., the grayscale voltage of the 31^{st} grayscale. Desired voltage gradients exist between the smoothing circuits 211, i.e., the voltages which are not subjected to smoothing have desired gradients. At the same time, desired grayscale voltages are generated at the 31^{st} grayscale that is smoothed and at the grayscales approximate to the 30 grayscale.

As shown in FIGS. 4 and 5, providing the smoothing circuits 211 causes the grayscale-by-grayscale voltage differences near the intermediate reference voltage to vary gradually. Specifically, as indicated by the two-dot chain line in FIGS. 4 and 5, if the smoothing circuits 211 were not used, the voltage differences between adjacent grayscales which are lower than the 30 grayscale would sharply vary from the voltage differences between adjacent grayscales which are higher than the 30 grayscale. In contrast to this, use of the smoothing circuits 211, as in this embodiment, can cause the voltage differences between the adjacent grayscales ranging from the 27^{th} grayscale through the 35^{th} grayscale to vary gradually. Consequently, when adjacent pixels has slightly different grayscales around the 30 grayscale, or when the grayscale of a pixel varies around the 30 grayscale as time progresses, for example, this configuration with smoothing circuits 211 easily enables avoidance of unnatural changes in brightness and thereby enables improvement of image quality. In particular, even when the intermediate reference voltages are variously adjusted according to, e.g., the characteristic of the liquid crystal panel 101, it is ensured that the smoothing effects are obtained near the intermediate reference voltages. In addition, this advantage can be obtained simply by providing the smoothing circuits 211 in the grayscale voltage generating circuit 202, without affecting the overall driving system for the liquid crystal panel 101 and without causing a large increase in costs of manufacturing.

In addition to the advantage that the use of the smoothing circuits 211 easily enables improvement of image quality, when the so-called overdrive that enhances grayscale transition is used, the effects of the overdrive are more appropriately obtained, according to the present disclosure. Specifically, during the overdrive, a grayscale compensator including a lookup table is used in the controller 106 for example. The lookup table is referred to for determining grayscale data corresponding to a voltage which is actually applied to the source lines 105, on the basis of grayscale data of a previous frame stored in a frame memory and grayscale data of a current frame. Normally, the lookup table includes not all of grayscale combinations, but representative and discontinuous grayscales as shown in FIG. 6, for example. The grayscales between the representative grayscales are determined by, e.g., linear interpolation. Accordingly, although the intermediate reference voltage such as VHR31 can be set from outside of the grayscale voltage generating circuit 202, it is difficult to set the lookup table such that the 31^{st} grayscale will be determined as grayscale data for the overdrive when certain grayscale data of the previous frame and certain grayscale data of the current frame are obtained. On the other hand, the use of the smoothing circuits 211 as in this embodiment easily enables the overdrive in a suitable manner, regardless of what grayscale is determined by linear interpolation as the grayscale data for the overdrive. This is because the use of the smoothing circuits 211 causes the grayscale-by-grayscale voltage differences to vary gradually, that is, because generated grayscale voltages are in a nearly linear shape between any adjacent grayscales. Consequently, by applying the present disclosure to, e.g., a liquid crystal display device for use in a three-dimensional television set (a 3DTV) which is required to be capable of particularly rapid display, it becomes easy to set voltages in a particularly flexible manner for the overdrive and to achieve rapid response capability and high image quality.

Note that the number of grayscales and smoothing accuracy of the smoothing circuits have been described above as an example. The configuration of the smoothing circuits is not limited to the foregoing and may be altered in various manners.

Although the above embodiment employs, as an example, the two-stage soothing as shown in FIG. 3, the present disclosure is not limited to the embodiment. For example, as illustrated in FIGS. 7 and 8, single-stage smoothing, in which a voltage is equally divided into the grayscale voltages VH29-VH33, may be applied to the present disclosure. On the other hand, smoothing in three or more stages may also be applied to the present disclosure. For example, when a voltage gradient varies at a first voltage point and voltage division and smoothing are performed between second and third voltage points sandwiching the first voltage point, voltage gradients also vary at the second and third voltage points. Repeating smoothing near the second and third voltage points can result in a higher degree of smoothing. A configuration in which the number of stages in which smoothing is performed varies from grayscale range to grayscale range depending on the degree of voltage gradient variation of each grayscale range is also applicable. Furthermore, the number of stages in which smoothing is performed in a low voltage side and the number of stages in which smoothing is performed in a high voltage side may be different from each other within the single smoothing circuit.

Use of the buffers 211a as described above makes it relatively easy to set an accurate ratio of voltage division. However, the buffers 211a are not necessarily required, depending on setting of resistance values of the voltage dividing resistors 202a and 211b or desired accuracy of grayscale voltages.

The voltage dividing resistors 202a and 211b are not necessarily required to have the same resistance value. For example, in a manner similar to Patent Document 1, the voltage dividing resistors 202a and 211b may have different resistance values according to the characteristic of the liquid crystal panel 101 or other conditions.

In the above embodiment, for convenience of explanation, the source driver 104 that generates grayscale voltages of a single polarity has been described. The present disclosure, however, is not limited to this configuration, and may include a source driver which generates grayscale voltages of positive and negative polarities for the so-called inversion drive.

In the above embodiment, the grayscale reference-voltage generating circuit 201 is provided in the source driver 104. The present disclosure, however, is not limited to this configuration. For example, the grayscale reference voltages may be supplied from outside of the source driver 104.

When the overdrive is performed, reference to the lookup table and the interpolation do not necessarily take place in the controller 106, and my take place in the source driver 104, for example.

### INDUSTRIAL APPLICABILITY

As described above, the present disclosure is useful for driving devices, driving methods, and systems for display devices which carry out grayscale display.

### DESCRIPTION OF REFERENCE CHARACTERS

101 Liquid crystal panel
102 Gate driver
103 Gate lines
104 Source driver
105 Source lines
106 Controller
201 Grayscale reference-voltage generating circuit
202 Grayscale voltage generating circuit
202a Voltage dividing resistors
203 Selector
204 Output buffer
211 Smoothing circuits
211a Buffers
211b Voltage dividing resistors

1. A driving device configured to drive a display device by outputting a grayscale voltage in accordance with a grayscale data signal, the driving device comprising:
a sequence of resistors connected to one another in series through nodes in such a manner that a highest reference voltage is applied to one end of the sequence of resistors, a lowest reference voltage is applied to the other end of the sequence of resistors, and at least one intermediate reference voltage is applied to at least one of the nodes; and
at least one smoothing circuit provided across ones of the nodes sandwiching the at least one node to which the intermediate reference voltage is applied and configured to smooth a voltage between the ones of the nodes sandwiching the at least one node to which the intermediate reference voltage is applied.

2. The driving device of claim 1, wherein
the smoothing circuit includes
two buffers configured to buffer voltages at two of the nodes sandwiching the at least one node to which the intermediate reference voltage is applied, and
a plurality of resistors configured to generate an intermediate voltage by dividing a voltage between voltages output by the two buffers.

3. The driving device of claim 1, wherein
the smoothing circuit includes voltage dividing circuits which are each configured to generate an intermediate voltage by dividing a voltage between two voltages, and are provided in multiple stages.

4. The driving device of claim 1, wherein
the at least one intermediate reference voltage comprises a plurality of intermediate reference voltages, the plurality of intermediate reference voltages are applied to ones of the nodes through which the resistors are connected to one another, and
the smoothing circuit is provided in relation to each of the nodes to which the intermediate reference voltages are applied.

5. The driving device of claim 1, further comprising:
a selector configured to select, according to the grayscale data signal, one voltage from the voltages at the nodes through which the resistors are connected to one another and the voltage output by the smoothing circuit.

6. The driving device of claim 1, further comprising:
a grayscale compensator configured to output, based on successive data on grayscales, the grayscale data signal which is compensated such that grayscale transition is enhanced.

7. The driving device of claim 6, wherein
the grayscale compensator includes a lookup table for determining compensated data on grayscales with respect to representative grayscales of the successive data on grayscales, and is configured to obtain, with respect to data on grayscales other than the representative grayscales, compensated data on grayscales by interpolation.

8. A method for driving a display device by outputting a grayscale voltage in accordance with a grayscale data signal, the method comprising:
applying a highest reference voltage to one end of a sequence of resistors connected to one another in series through nodes, a lowest reference voltage to the other end the sequence of resistors, and an intermediate reference voltage to at least one of the nodes; and
generating a voltage for driving the display device based on a voltage obtained by smoothing a voltage between ones of the nodes sandwiching the at least one node to which the intermediate reference voltage is applied.

9. A system comprising:
the driving device of claim 1; and
a display device driven by the driving device.

10. The system of claim 9, wherein
the display device is a liquid crystal display device.
